(19) United States
(12) Patent Application Publication
(10) Pub. No.: US 2009/0252849 A1
(43) Pub. Date: Oct. 8, 2009

(54) Milk powder and method of manufacture

(76) Inventor: Michael John Phillips, Victoria (AU)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/665,334

(22) PCT Filed: Oct. 13, 2005
(86) PCT No.: PCT/AU05/01588

§ 371 Date: Jun. 1, 2009

(30) Foreign Application Priority Data
Oct. 15, 2004 (AU) 2004905938

(51) Int. Cl. A23C 9/16; A23C 9/15; A23C 9/00

(52) U.S. Cl. 426/588

(57) ABSTRACT

A method for the processing of milk ultrafiltration permeate created during the manufacture of milk protein concentrate (MPC) and/or whey protein concentrate (WPC) to produce a reduced-protein milk powder, which nevertheless has useful functional and sensory properties.

### FIELD OF THE INVENTION

The invention relates to the field of dairy-derived food ingredients. In particular, it relates to an improved milk powder for use as a food ingredient, and a method of preparing same.

### BACKGROUND TO THE INVENTION

Modern technology has allowed the fractionation of milk into its individual components, which are valued and used for their intrinsic functional benefits. In particular, ultra-filtration and other membrane based technologies have been used to manufacture high protein milk protein concentrates (MPC's) and whey protein concentrates (WPC's). The manufacture of these products results in the generation of significant quantities of permeates, a large proportion of which are disposed of at cost to the manufacturer, or utilised in relatively low value applications such as lactose extraction or stock feed manufacture.

Total world production of MPC's and WPC's is significant and growing. It is estimated that this results in the generation of 1.5 million metric tonnes of permeate solids. Lactose may be extracted from these permeate solids, but the low commercial returns for lactose renders this operation at marginal financial feasibility at best. In addition, this would still leave approximately 30% of the feed solids as lactose mother liquor, which is typically dumped at a cost to the manufacturer.

The dumping of the 1.5 million metric tonnes of permeate solids produced also tends to create environmental problems.

In addition, lower protein milk powders known in the prior art tend to have poorer functionality, particularly in relation to flavour profile. It would be advantageous to provide lower protein milk powders which perform as well as standard milk powders.

Consequently, it is an object of the present invention to provide a method of deriving commercially viable products from otherwise ‘waste’ permeate solids.

### SUMMARY OF THE INVENTION

According to its broadest aspect, the invention provides a method for the processing of milk ultrafiltration permeate created during the manufacture of milk protein concentrate (MPC) and/or whey protein concentrate (WPC) to produce a reduced-protein milk powder, which nevertheless has useful functional and sensory properties.

In particular, by combining said permeate with a volume of skim or whole milk, it has been found possible to prepare a reduced-protein milk powder for a range of different applications which surprisingly deliver the required functionality at a lower cost than traditional milk powders.

However, the ability to produce modified milk powders with significantly lower protein content in conventional milk powder plants is limited by the hygroscopic nature of the amorphous lactose in the milk, which adversely affects the drying process of the powder due to the higher effective content of lactose in the drying feedstock. Thus, there is a need for an improved process to produce these modified milk powders, which alleviates this problem.

According to another aspect of the invention, there is provided a method for the production of modified milk powder, said method including the steps of:

preparing a standardised milk (skimmed, semi-skimmed or full cream);

concentrating in an evaporator to total solids of around 50% by weight;

cooling in a controlled manner to achieve partial crystallisation of the lactose; and

then spray drying the crystallised concentrate.

Crystallising a portion of the lactose in the modified milk powder before drying allows a modified milk concentrate with as little as 6% protein (dry non-fat matter basis) to be dried without adversely affecting the quality of the powder.

According to another aspect of the invention, there is provided a reduced-protein milk powder, preferably having a protein content of less than 25% by weight dry non-fat matter, which has enhanced functional performance in the preparation of food products, as obtained by the method described above. Using the method described above, it is possible to provide a reduced-protein milk powder a protein content as low as 6% by weight dry non-fat matter.

The inventors have surprisingly found that milk powders with significantly reduced protein levels, as obtained via the inventive method, can perform as well as standard milk powders (which typically have a protein content of at least 34% of non-fat dry matter) in at least some applications. Further, the inventors have also found that such powders perform better than blends of milk powder and lactose.

The advantage provided by the invention is the ability to spray dry a modified milk concentrate containing between 6% and 25% protein on a dry non-fat basis.

For example, according to the invention, fresh skim milk may be standardised to a desired protein to solids-non-fat level, typically about 10 to 12%. This standardisation is generally carried out by adding the appropriate amount of milk permeate to the fresh skimmed milk. This can also be done by composing suitable liquid milks from fresh whole milk, partially skimmed milk, cream, butterfat, buttermilk, lactose, etc.

The milk may then be partially demineralised, or alternatively, one of the feed streams may be partially demineralised. This may be done by nano-filtration, ion exchange or any of the other technologies known to those skilled in the art. The modified milk is then subjected to a heat treatment for pasteurisation. The heat treated milk is then fed into an evaporator and concentrated to around 50% by weight, but preferably 55% by weight total solids.

The concentrate is then cooled, in a controlled manner, to crystallise a portion of the lactose. Once adequate crystallisation of the lactose has occurred, spray drying of the concentrate can be carried out preferably with a rotary disc atomiser to introduce the partially crystallised concentrate to the drier.

The further processing of the milk powder after the atomisation step comprising drying, cooling, storage and packing is then completed according to the standard known to experts in the field.

It is also expected that a similar result could be obtained by mixing crystallised milk permeate with concentrated milk solids before drying, cooling and packing as described above. Further, this technology could also be used to produce fat-filled milk powders and even non-dairy milk powder replacers from permeates.

According to another aspect of the invention, there is provided a method for the production of modified full cream milk powder, said method including the steps of:

preparing a standardised milk;

concentrating in an evaporator to total solids of around 50% by weight;

cooling in a controlled manner to achieve partial crystallisation of the lactose;

blending the crystallised concentrate with homogenised cream in such a ratio as to ensure the finished product composition, and;

then spray drying the crystallised concentrate blend.

The above method is preferred where production of a full-cream milk powder is desired.

According to another aspect of the invention, there is provided a reduced protein skim milk powder manufactured according to the process as defined above.

According to another aspect of the invention, there is provided a reduced protein full cream milk powder manufactured according to the process as defined above.

According to another aspect of the invention, there is provided the use of reduced protein milk powders as described above in the manufacture of food products.

According to another aspect of the invention, there are provided commercially prepared food products resulting from the use described above.

### DETAILED DESCRIPTION OF PREFERRED EMBODIMENTS

The invention will now be described by way of a specific, non-limiting example. In the following examples, parts and percentages are by weight unless otherwise specified.

### Example 1

### Preparation of Reduced Protein Skim Milk Powder

In preparing a modified milk powder according to the invention, 26,066 kg of skim milk containing 3.73% protein, 0.11% fat and 9.26% non-fat solids was mixed with 97,618 kg of waste milk permeate containing 0.33% protein, 0.02% fat and 8.81% non-fat solids to form 123,684 kg of modified milk with 1.04% protein, 0.04% fat and 8.91% non-fat solids.

The mixture was passed by a centrifugal pump through the pre-heater of an evaporator where it was heated to a temperature of 80° C. and held for 5 seconds before passing into the first effect of a multiple effect falling film evaporator.

After being concentrated to 53% total solids the concentrate was cooled to 32° C. through a plate heat exchanger and filled into a crystalliser (25,000 L capacity, supplied by APV Australia), where it was further cooled down to 10° C. over a period of 12 hours.

The crystallised concentrate was then spray dried to produce 11,231 kg of modified milk powder containing 11.5% protein, 0.4% fat and 1.5% moisture. The powder was then cooled and packed.

### Example 2

### Preparation of Reduced Protein Full Cream Milk Powder

In preparing a modified full cream milk powder according to the invention, 4,334 kg of crystallised concentrate (prepared according to Example 1) containing 5.94% protein, 0.14% fat and 53.0% total solids was mixed with 2,206 kg of homogenised cream (homogenised at 40 Bar) containing 1.90% protein, 40.0% fat and 5.52% non-fat solids to form 6,540 kg of modified full cream milk concentrate. This concentrate contained 4.58% protein, 13.58% fat and 50.48% total solids.

The crystallised concentrate was then spray dried to produce 3,351 kg of modified full cream milk powder containing 8.93% protein, 26.5% fat and 1.5% moisture. The powder was then cooled and packed.

### Example 3

### Use of Reduced Protein SMP in UHT Milk

A 12.5% protein milk powder, prepared according to the process described in Example 1, was screened in UHT milk formulations. As a control, recombined milk was prepared from whole milk powder (WMP), having 3.5% fat, 12.5% total solids and 3.21% protein. A stabiliser (Degussa XSA BN325) was added at 0.4%.

The mix was heat treated in an UHT process at 138° C. for 3 seconds, cooled to 70° C., homogenised at 150 bar (single stage homogeniser), and cooled to 30° C. Samples were refrigerated immediately after collection.

Three further batches were prepared, replacing WMP solids with a milk powder prepared according to Example 1 and anhydrous milk fat (AMF) to produce a similar composition to the control milk. WMP solids substitution was made at 10%, 20% and 30% of total solids. The corresponding protein levels were calculated to be 3.00%, 2.82% and 2.61% at these substitution rates. The milks were processed with the same conditions as the control. Each of the samples then underwent informal sensory evaluation.

Very few discernable differences were found between samples. Almost all tasters had a preference for the 30% replacement product, which was judged to have a slightly sweeter flavour.

There were no differences in the thickness and mouth-feel characteristics of the four milks, indicating a successful use of the product according to the invention in milk.

### Example 4

### Use of Reduced Protein SMP in Flavoured UHT Milk

Following the results of the above Example 3 trials using 12.5% protein permeate powder in UHT milk formulations, further trials were undertaken looking at manufacturing flavoured milks with SMP replacement up to 70% of non-fat solids.

For this trial, a typical vanilla malt flavoured milk formulation was prepared. Milk was recombined from whole milk powder (WMP) at 3.5% fat, 12.5% total solids and 3.21% protein. Sugar, flavour and stabiliser premix was added as per a typical vanilla malt flavoured milk formulation familiar to those skilled in the art.

The formulation was heat treated in a UHT process at 100° C. for 3 seconds, cooled to 70° C., homogenised at 100 & 50 Bar (in a two stage homogenisation process), and cooled to 30° C.

Three further batches were prepared, replacing WMP solids with a milk powder prepared according to Example 1 and AMF to produce a similar composition to the control. WMP solids substitution was made at 30%, 50% and 70%. The protein levels were calculated to be 2.35%, 1.56%, 1.08% and 0.59% for the different rates of substitution. The modified milks were processed with the same conditions as the control. Each of the samples then underwent informal sensory evaluation.

Very few discernable differences were found between the samples at up to 50% substitution. The 70% substitution sample did have a slightly different mouth feel and some tasters felt there was some mineral aftertaste compared with the lower substitution samples. However as a stand alone product, the milk was still judged to be very acceptable.

### Example 5

### Use of Reduced Protein SMP in Flavoured Milk

Five flavoured milks were then prepared using typical fresh flavoured milk flavours and formulations familiar to those skilled in the art. For each flavour, a control was prepared using fresh whole milk, along with a test batch with 50% of the non-fat solids replaced by a milk powder prepared according to Example 1 (MPC11). Cream was added to normalise the fat level in the test batch. The milks so prepared were pasteurised at 80° C. for 15 secs, homogenised at 100 & 50 Bar in a two stage homogenisation process and cooled to 6° C. The flavours prepared were Vanilla Malt, Chocolate, Coffee, Strawberry and Banana.

Samples were evaluated informally for organoleptic properties. There were general comments made by the testers that the samples with MPC11 added and flavoured with vanilla malt, chocolate and coffee had more body and/or a creamier mouth-feel. The flavour intensity also seemed to be slightly higher in the products with MPC 11 added. No such differences were noted with the strawberry and banana flavoured milks.

### Example 6

### Use of Reduced Protein SMP (RPSMP) in White and Chocolate Flavoured UHT Milk

Further trials of UHT milk were run with RPSMP replacing 50% of the non-fat solids. These included four white milk formulations and four chocolate flavoured milk formulations. The white milk formulations were:
1. A control made from WMP with 0.02% carrageenan added.
2. Milk with 50% of the non-fat solids replaced with High Ash RPSMP with cream added to adjust the fat level.
3. Milk with 50% of the non-fat solids replaced with Low Ash RPSMP with cream added to adjust the fat level.
4. Milk with the same protein level as the RPSMP milks made with lactose and with cream added to adjust the fat level.

Analyses of the white milk formulations are given in the table below:

| | | 2. 50% High | 3. 50% Low | |
|---|---|---|---|---|
| White Milk | 1. Control | Ash | Ash | 4. Lactose |
| Total Solids % | 12.49 | 12.56 | 12.69 | 12.77 |
| Fat % | 3.71 | 3.67 | 3.69 | 3.89 |
| Lactose % | 5.1 | 6.3 | 6.3 | 6.6 |
| Phosphorus % | 0.09 | 0.079 | 0.083 | 0.058 |
| Chloride % | 0.09 | 0.11 | 0.10 | 0.06 |

The flavour testing results, by informal evaluation of cold products were:
Control: Slightly powdery with good creaminess and mouth feel.
50% High Ash: Clean and good mouth feel and good flavour. No powdery taste.
50% Low Ash: Similar to high ash product.
50% Lactose: Sweeter than others. Thin and lacking body.

For the chocolate milk evaluation, four milks were produced.
1. A control made from WMP with an added chocolate premix, supplied by International Flavours and Fragrances under item no. SN498212, included at 5.32 g/L.
2. Milk with 50% of the non-fat solids replaced with High Ash RPSMP with cream added to adjust the fat level.
3. Milk with 50% of the non-fat solids replaced with Low Ash RPSMP with cream added to adjust the fat level.
4. Milk with the same protein level as the RPSMP milks made with lactose and with cream added to adjust the fat level.

Analyses of the chocolate milk formulations are given in the table below:

| | | 2. 50% High | 3. 50% Low | |
|---|---|---|---|---|
| Chocolate Milk | 1. Control | Ash | Ash | 4. Lactose |
| Total Solids % | 16.96 | 17.02 | 17.12 | 17.07 |
| Fat % | 3.45 | 3.4 | 3.41 | 3.53 |
| Lactose % | 4.9 | 6.0 | 5.9 | 6.1 |
| Phosphorus % | 0.087 | 0.076 | 0.078 | 0.055 |
| Chloride % | 0.08 | 0.11 | 0.11 | 0.05 |

The flavour testing results, by informal evaluation of cold products were;
Control: Thick and good chocolate flavour.
50% High Ash: Good mouth feel. Very good natural chocolate flavour. The chocolate flavour was enhanced and was well balanced
50% Low Ash: Similar to high ash product.
50% Lactose: Thin and lacking mouth feel. Slightly artificial chocolate flavour. Not balanced.

### Example 7

### Use of Reduced Protein Skim Milk Powder (RPSMP) in Milk Chocolate

A trial was run to assess the suitability of an RPSMP prepared in accordance with Example 1, as well as a Skim Milk Powder (SMP)/Lactose blend, in a milk chocolate application. In these trials, three chocolate samples were prepared and examined. These were identified as:
1. Control (100% SMP)
2. 100% replacement of SMP with RPSMP
3.67% replacement of SMP with Lactose.

Each of the chocolates manufactured was assessed in terms of ease of processing and handling, final product colour, Casson plastic viscosity, yield value, particle size, hardness, snap and organoleptic attributes.

The base milk chocolate formulation for 25 kg batches of each of the three above chocolates is shown in the table below.

| | | Trial 1: | Trial 2: | Trial 3: |
|---|---|---|---|---|
| | | SMP Control | RPSMP | SMP/Lactose |
| Ingredient | % | (kg) | (kg) | Blend (kg) |
| Castor Sugar | 43 | 10.75 | 10.75 | 10.75 |
| Cocoa Butter | 21 | 5.25 | 5.25 | 5.25 |
| Cocoa Liquor | 11.5 | 2.875 | 2.875 | 2.875 |
| SMP | 17.7 | 4.425 | | 1.46 |
| | (5.8*) | | | |
| RPSMP | (17.7) | — | 4.425 | — |
| Lactose | (11.9) | — | — | 2.965 |
| AMF | 6.2 | 1.55 | 1.55 | 1.55 |
| Lecithin | 0.57 | 0.1425 | 0.1425 | 0.1425 |
| Vanillin | 0.03 | 0.0075 | 0.0075 | 0.0075 |
| TOTAL | 100 | 25.00 | 25.00 | 25.00 |

*Quantity of SMP required in trial 3

The samples were manufactured according to chocolate manufacturing processes well known to those skilled in the art. The surface colour of the moulded chocolate blocks was measured using a Minolta Chromameter.

| | Colour Measurements | | |
|---|---|---|---|
| Sample ID | L | a | b |
| 1. Control 100% SMP | 43.18 | 7.02 | 7.70 |
| 2. RPSMP | 44.45 | 7.37 | 8.25 |
| 3. SMP/Lactose Blend | 42.99 | 7.06 | 7.14 |

Slight differences were noted in colour for the SMP/Lactose blend compared with the two other chocolate samples, however this difference was not significant, indicating that milk powder type had little effect on the overall colour readings.

The particle size of the chocolates was measured using a digital micrometer. The results shown are an average of three consecutive measurements. These measurements only act as a guide and do not give the particle size distribution of the chocolate.

| Sample ID | Particle Size (μm)* |
|---|---|
| 1. Control 100% SMP | 23 |
| 2. RPSMP | 22 |
| 3. SMP/Lactose Blend | 20 |

*average of three consecutive measurements

All chocolates manufactured had a similar particle size, indicating similar response to processing conditions by all formulations.

The plastic viscosity is a measure of how easily the chocolate flows once it has started flowing. The yield value is the force required to start the chocolate flowing. The viscosity and yield values given in the table below were measured according to the NCA/CMA Viscosity Method.

| | Plastic Viscosity | Yield Value |
|---|---|---|
| Sample ID | (Poise) | (Dynes/cm²) |
| 1. Control 100% SMP | 21.12 | 159.06 |
| 2. RPSMP | 23.21 | 187.98 |
| 3. SMP/Lactose Blend | 22.91 | 194.42 |

There was some variation within viscosity results, with both the RPSMP and the SMP/Lactose blend producing chocolate samples that had a slightly higher viscosity compared with the control. The RPSMP milk powder and the SMP/Lactose blend both had a slightly higher yield values compared to the control, which would indicate that more force would be required to get these masses of chocolate moving.

The “snap” test is a three point bend test which mimics the breaking of a chocolate block into two pieces. This will give comparative measurements as to the hardness of the chocolate, which will give an indication of the chocolate texture and effects of the powders on the chocolate texture. The ‘snap’ value of the chocolates given in the table below were measured using a TA-XT2 texture analyzer.

| Sample | Snap (grams)* |
|---|---|
| 1. Control 100% SMP | 3752 |
| 2. RPSMP | 4191 |
| 3. SMP/Lactose Blend | 4893 |

*average of three consecutive readings

The SMP/Lactose blend chocolate sample required a greater force to initiate snap compared to the control and RPSMP formulations.

The hardness measurement of a product is a compression test and closely simulates the human action of taking the initial bite. The hardness of the chocolate samples, as shown in the following table, was measured using a TA-XT2 texture analyzer.

| Sample | Hardness (grams)* |
|---|---|
| 1. Control 100% SMP | 1166 |
| 2. RPSMP | 1168 |
| 3. SMP/Lactose Blend | 1225 |

*average standard deviation (±31 g)

The SMP/Lactose blend chocolate was found to be slightly harder than the control and the RPSMP samples.

An informal taste panel was used to assess the flavour of the chocolate samples. The results of these tests are given in the table below.

| Sample | Description |
|---|---|
| 1. Control 100% SMP | Sweet, clean creamy flavour |
| | with a smooth mouthfeel. |
| 2. RPSMP | Sweeter than control, slight |
| | caramelized flavour, smooth |
| | mouthfeel, creamy |
| 3. SMP/Lactose Blend | Sweet, less overall milk |
| | flavours, less creamy, smooth |
| | mouthfeel |

All the chocolate samples manufactured were found to have an acceptable flavour. Some flavour variations were noted in the SMP/Lactose blend sample, which had relatively less flavour compared to the other samples.

The main finding of the above study is that chocolate manufactured having 100% of standard SMP replaced by RPSMP manufactured in accordance with the invention is likely to meet normal quality requirements for chocolate.

### Example 8

### Use of Reduced Protein Full Cream Milk Powder (RPFCMP) in Chocolate

A trial was done to assess the suitability of RPFCMP in replacing full cream milk powder (FCMP) in a chocolate formulation. Two chocolate samples were prepared and examined, on a control including FCMP and the test batch featuring 100% replacement of FCMP with a RPFCMP prepared in accordance with Example 2. Both of these chocolates manufactured were assessed in terms of ease of processing and handling, colour, Casson plastic viscosity, yield value, particle size, hardness, snap and organoleptic attributes.

The base milk chocolate formulation for 20 kg batches of the two chocolate formulations is shown the table below.

| | | Control FCMP | Full Cream Choc |
|---|---|---|---|
| Ingredient | % by mass | (Kg) | Plus (Kg) |
| Caster Sugar | 43 | 8.6 | 8.6 |
| Cocoa Butter | 21 | 4.2 | 4.2 |
| Cocoa Liquor | 11.5 | 2.3 | 2.3 |
| Control FCMP | (23.9) | 4.78 | — |
| RPFCMP | (23.9) | — | 4.78 |
| Lecithin | 0.57 | 0.114 | 0.114 |
| Vanillin | 0.03 | 0.006 | 0.006 |
| TOTAL | 100 | 20.00 | 20.00 |

The samples were manufactured according to chocolate manufacturing processes well known to those skilled in the art.

The surface colour of the moulded chocolate blocks was measured using a Minolta Chromameter. The results are shown in the following table:

| | Colour Measurements | | |
|---|---|---|---|
| Sample ID | L | a | b |
| 1 . Control FCMP | 42.35 | 7.19 | 10.03 |
| 2. RPFCMP | 40.30 | 6.99 | 9.13 |

Milk powder type was found to have little effect on the overall colour readings. The particle size of the chocolates was measured using a digital micrometer. The results given are an average of three consecutive measurements. These measurements only act as a guide and do not give the particle size distribution of the chocolate.

| Sample ID | Particle Size (μm)* |
|---|---|
| 1. Control FCMP | 19 |
| 2. RPFCMP | 20 |

*average of three consecutive measurements

Both chocolates manufactured had a similar particle size, indicating similar response to processing conditions.

Plastic viscosity is a measure of how easily the chocolate flows once it has started flowing. The yield value is the force required to start the chocolate flowing. The viscosity and yield value of both formulations were measured according to the NCA/CMA Viscosity Method, and the results are given in the following table.

| | Plastic Viscosity | Yield Value |
|---|---|---|
| Sample ID | (Poise) | (Dynes/cm²) |
| 1. Control FCMP | 29.86 | 208.43 |
| 2. RPFCMP | 28.10 | 230.87 |

The “snap” test is a three point bend test which mimics the breaking of a chocolate block into two pieces. This will give comparative measurements as to the hardness of the chocolate, which will give an indication of the chocolate texture and effects of the powders on the chocolate texture. The ‘snap’ values of the chocolates were measured using a TA-XT2 texture analyser, and are shown in the following table.

| Sample | Snap (grams) |
|---|---|
| 1. Control FCMP | 4610 |
| 2. RPFCMP | 4892 |

The RPFCMP product was found to require slightly more force to initiate snap in comparison to the control FCMP product.

The hardness measurement of a product is a compression test and closely simulates the human action of taking the initial bite. The hardness of the two chocolate formulations was measured using a TA-XT2 texture analyzer. The results are shown in the following table.

| Sample | Hardness (grams)* |
|---|---|
| 1. Control FCMP | 1341 |
| 2. RPFCMP | 1448 |

*average standard deviation (±75.6 g)

An informal taste panel was used to assess the flavour of the chocolate samples. It must be noted that the results are subjective and as a limited number of people were involved in this assessment further investigation would be required to accurately assess consumer preference.

| Sample | Description |
|---|---|
| 1. Control FCMP | Smooth and creamy |
| | mouthfeel, slightly |
| | caramelized, good |
| | chocolate flavours |
| 2. RPFCMP | Smooth and creamy |
| | mouthfeel, more |
| | caramelized flavours and |
| | slightly sweeter compared |
| | to commercial powder |

Both chocolate samples manufactured were found to have an acceptable flavour, with the RPFCMP product having slightly more caramelized and sweeter flavours than the Control FCMP product.

The main finding of the above study is that chocolate manufactured having 100% of standard FCMP replaced by RPFCMP manufactured in accordance with the invention is likely to meet normal quality requirements for chocolate.

### Example 9

### Use of Reduced Protein SMP in Bakery Applications

Trials have been carried out to determine the suitability of RPSMP prepared in accordance with Example 1 as a replacement for skim milk powder in a range of bakery applications—bread, Asian style Pan Dan cake, biscuits, donuts and custard. The main finding from this study was that the use of both milk powders improved the quality and acceptability of these baked products, and that this effect was enhanced in some applications by the use of the RPSMP as compared with use of SMP.

### Example 10

### Use of Reduced Protein Full Cream Milk Powder (RPFCMP) in UHT Milk

An 8.7% protein RPFCMP containing 23.3% milk fat was prepared according to the process described in Example 2. The effectiveness of the milk powder was evaluated by inclusion in UHT milk formulations.

A control recombined milk was prepared from whole milk powder (WMP) to give a composition including 3.3% fat, 12.5% total solids and 3.35% protein. A stabiliser (Kelcogel HMB) was added at 0.1%.

The mix was treated in an UHT process at 138° C. for 3 seconds, cooled to 70° C., homogenised at 30 & 20 Bar (in a double stage homogenisation process), and cooled to 30° C. Samples were refrigerated immediately after collection.

Two further batches were prepared, in which a RPFCMP prepared according to the invention was used to replace WMP solids to give similar composition to the control. WMP solids substitution was made at 50% and 70%. The calculated protein levels were 2.34% and 1.95%. The milks were processed with the same conditions as the control. Each of the samples then underwent informal sensory evaluation.

Very few discernable differences were found between samples. Almost all tasters had a preference for the 50% replaced product, which was judged to have a slightly sweeter flavour and, surprisingly, a much fresher and ‘less cooked’ flavour.

There were no differences in the thickness and mouth-feel characteristics of the three milks.

### Example 11

### Use of Reduced Protein Skim Milk Powder (RPSMP) in Recombined Sweetened Condensed Milk (RSCM)

Three batches of RSCM were prepared according to the formulations given in the following table. Of the three batches, two represented partial (20% and 50%) replacement of SMP with a reduced protein SMP prepared according to the invention.

| | Property | | |
|---|---|---|---|
| | | 20% SMP | 50% SMP |
| Ingredient | 100% SMP | Replacement | Replacement |
| Skim Milk Powder | 1.59 | 1.272 | 0.795 |
| RPSMP | — | 0.318 | 0.795 |
| Palm Oil | 0.585 | 0.585 | 0.585 |
| Sugar | 3.375 | 3.375 | 3.375 |
| Water | 2.08 | 2.08 | 2.08 |
| Total Solids | 71.9% | 71.9% | 71.9% |
| Viscosity (cP) | 2,100 | 6,100 | 12,000 |

The batches were mixed, heated to 80° C. and vacuum cooled to 40° C. The batches were seeded with lactose at 45° C. Surprisingly, the viscosity of the RSCM increased as the reduced protein SMP content was increased—this was unexpected, given the lower protein content of the reduced protein SMP.

### Example 12

### Use of Protein Skim Milk Powder (RPSMP) in Ice Cream

Two batches of ice cream were prepared. The first was prepared as a control using SMP. The second was prepared using a RPSMP, prepared according to the invention, replacing the SMP as the sole source of non-fat milk solids. The ice creams were prepared according to the formulations given in the following table:

| Ingredients (%) | Control | Test |
|---|---|---|
| SMP | 12.0 | — |
| RPSMP | — | 12.0 |
| Sucrose | 14.0 | 14.0 |
| Vegetable Fat | 10.0 | 10.0 |
| Stabiliser | 0.5 | 0.5 |
| Vanilla Flavour | 0.1 | 0.1 |
| Water | 63.4 | 63.4 |

Both ice cream blends were heat treated, homogenised, cooled, crystallised and churned according to a standard ice cream manufacturing process well known to those skilled in the art.

No differences were noticed between the two batches during processing. Both ice cream products had similar over-run and stability and were judged to be very similar organoleptically.

All of the above results attest to the ability of waste milk permeate product to be used in the manufacture of a modified milk powder which can partially or wholly replace standard milk powders in various food-related applications. This results in a commercially viable disposal mechanism for said permeates.

It will be understood by those skilled in the art that the above examples of the inventive method, and uses of the resultant product, represent a relatively limited indication of the ways in which such milk products may be disposed of, whilst remaining within the spirit and scope of the invention.

1. A method of commercially advantageous disposal of milk ultrafiltration permeate, created during the manufacture of milk protein concentrate (MPC), said method including the steps of:
combining said permeate with a volume of skim or whole milk;
drying said combination to form a reduced-protein milk powder having a protein content of between 6% and 25% by weight on a non-fat dry solids basis; and
using the permeate so processed as a functional ingredient in food products, in particular using the permeate so processed as an extender for higher cost functional ingredients.

2. The method of claim 1, further including the steps of:
prior to drying, concentrating said combination of permeate and skim or whole milk in an evaporator to total solids of around 50% by weight;
cooling said concentrated combination in a controlled manner to achieve partial crystallisation of the lactose; and
spray drying the crystallised concentrate to form a reduced-protein milk powder.

3. The method of claim 2, wherein the permeate, the skim or whole milk or the combination of permeate and skim or whole milk is partially demineralised before drying.

4. The method of claim 3, wherein the combination of permeate and skim or whole milk is then subjected to a heat treatment before drying.

5. The method of claim 4, wherein the heat treated milk is, before drying, fed into an evaporator and concentrated to around 50% total solids by weight, but preferably 55% total solids by weight.

6. The method of claim 5, wherein the crystallised concentrate is combined with homogenised cream and dried to produce a reduced protein full cream milk powder.

7. A reduced-protein milk powder as obtained by the method of claim 1.

8. Use of the reduced-protein milk powder of claim 7 in the manufacture of food products.

9. The use of claim 8, wherein the food product is commercially prepared milk.

10. The use of claim 8, wherein the food product is commercially prepared flavoured milk.

11. The use of claim 8, wherein the food product is commercially prepared baked goods.

12. The use of claim 8, wherein the food product is commercially prepared ice cream.

13. The use of claim 8, wherein the food product is commercially prepared chocolate.

14. The use of claim 8, wherein the food product is commercially prepared UHT milk.

15. The food products of claim 8.

16-19. (canceled)
